(19) United States
(12) Patent Application Publication
(10) Pub. No.: US 2023/0332437 A1
(43) Pub. Date: Oct. 19, 2023

(54) LOCKING PULL HANDLE DOGGING MECHANISM

(71) Applicant: ASSA ABLOY Accessories and Door Controls Group, Inc., New Haven, CT (US)

(72) Inventors: Luke E. Clay, Rockwood, PA (US); Michael Connell, Connellsville, PA (US); Sam Wiedner, Friedens, PA (US)

(73) Assignee: ASSA ABLOY Accessories and Door Controls Group, Inc., New Haven, CT (US)

(21) Appl. No.: 18/131,792

(22) Filed: Apr. 6, 2023

Related U.S. Application Data
(60) Provisional application No. 63/330,682, filed on Apr. 13, 2022.

(51) Int. Cl. E05B 63/18; E05C 1/00; E05C 1/16; E05B 55/00

(52) U.S. Cl. CPC E05B 63/18; E05C 1/006; E05C 1/163; E05B 55/00

(57) ABSTRACT

A pull handle may include a chassis, a latch disposed at least partially in the chassis, a thumb turn, and a dogging fastener movably disposed on the thumb turn. The thumb turn may be rotatable between a locking position and an unlocking position, where the thumb turn is coupled to the latch such that when the thumb turn is in the locking position the latch is in an extended position and when the thumb turn is in the unlocking position the latch is in a retracted position. The dogging fastener may be configured to move between a dogging position and an undogging position, where in the dogging position the dogging fastener engages the chassis to inhibit rotation of the thumb turn.

### RELATED APPLICATIONS

This application claims the benefit under 35 U.S.C. § 119(e) to U.S. Provisional Application No. 63/330,682, filed on Apr. 13, 2022, which is herein incorporated by reference in its entirety.

### FIELD

Disclosed embodiments are related to locking pull handles, dogging mechanisms for locking pull handles, and related methods of use.

### BACKGROUND

Exit devices and/or pull handles are typically employed on glass doors in compact arrangements so as to limit the visual interference with the glass door. These conventional exit devices typically include a push bar to actuate one or more vertical rods to selectively latch or unlatch the glass door. Some conventional pull operated devices may operate in a similar manner but with a pull direction instead of a push direction.

### SUMMARY

In some embodiments, a pull handle includes a chassis including a handle portion configured to be grasped by an operator. The pull handle also includes a latch disposed at least partially in the chassis and configured to move between an extended position and a retracted position, where in the extended position the latch is configured to protrude out of the chassis. The pull handle also includes a thumb turn rotatable between a locking position and an unlocking position, where the thumb turn is coupled to the latch such that when the thumb turn is in the locking position the latch is in the extended position and when the thumb turn is in the unlocking position the latch is in the retracted position. The pull handle also includes a dogging fastener disposed on the thumb turn, and configured to move between a dogging position and an undogging position, where in the dogging position the dogging fastener engages the chassis to inhibit rotation of the thumb turn relative to the chassis.

In some embodiments, a method of operating a pull handle includes rotating a thumb turn of the pull handle from a locking position to an unlocking position to move a latch of the pull handle from an extended position to a retracted position, and moving a dogging fastener from an undogging position to a dogging position to engage a chassis of the pull handle, where engaging the chassis with the dogging fastener inhibits rotation of the thumb turn relative to the chassis.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 depicts one embodiment of a glass door including a locking pull handle

FIG. 2 is a side schematic of one embodiment of a locking pull handle;

FIG. 3 is a schematic of one embodiment of an actuator of a locking pull handle in a first position;

FIG. 4 is a schematic of the actuator of FIG. 3 in a second position;

FIG. 5 is a perspective view of one embodiment of a thumb turn of a locking pull handle in a first position; and

FIG. 6 is a perspective view of the thumb turn of FIG. 5 in a second position.

### DETAILED DESCRIPTION

Exit devices and/or pull handles are typically employed on glass doors in compact packages to allow simple actuation of a door latch or operation of the door while minimizing the aesthetic impact to the glass door. For example, an exit device actuator or a pull handle may be housed in a cylindrical chassis which occupies a small portion of the overall door surface area. However, due to the limited space constraints for such exit devices and/or pull handles, the functionality of the exit device or handle may be limited relative to traditional door hardware. For example, some conventional devices may include manual latches or no latches at all. Additionally, conventional pull handles may not latch, and may not be able to be dogged in an unlatched position in a reliable and easy manner.

In view of the above, the inventors have recognized the benefits of a dogging arrangement for a locking pull handle that may be employed on a glass door. The dogging arrangement may be easy to use for an operator of the door. Additionally, the dogging arrangement may be usable based on a usual movement of a thumb turn of a latch pull handle. Accordingly, the dogging arrangement of exemplary embodiments described herein may be employed to hold a door in an unlatched (e.g., dogged) state reliably, which may improve the functionality of a latch pull handle in many commercial buildings such as offices, hospitals, etc., where a door may be often kept in an unsecure state. The inventors have also appreciated that such a dogging arrangement may be implemented on a variety of locking devices, including latch pull handles or exit devices.

In some embodiments, a pull handle is configured to be coupled to a door (e.g., a glass door). The pull handle may include a chassis. In some embodiments, the chassis may be tubular (e.g., cylindrical, square, etc.) and may have a handle portion configured to be grasped by an operator. In some embodiments, the chassis may house an actuator configured to move a latch from an extended position to a retracted position when the handle portion is pulled by an operator. In some embodiments, the chassis may be rigidly coupled to the door and any latch may be operated by an externally accessible actuator (e.g., lock cylinder, thumb turn, handle, etc.). The pull handle may include a latch that is configured to secure the door to an associated door frame. In some embodiments, the latch may be configured to protrude out of a top of the chassis or a bottom of the chassis to engage a transom or threshold of a door frame, respectively. In some embodiments, the latch may include a flat locking face configured to provide enhanced security relative to fully round latches. In some embodiments, the latch may be biased toward an extended position and in such embodiments may automatically secure the door when the door in in a closed position.

In some embodiments, a pull handle may include a thumb turn that is rotatable between a locking position and an unlocking position. The thumb turn may be rotatable mounted to a chassis and may be configured to move an associated latch between an extended position and a retracted position. In some embodiments, the thumb turn may be grasped by an operator to operate the associated latch. In the locking position the thumb turn may extend the latch to the extended position. In the unlocking position, the thumb turn may retract the latch into the chassis or otherwise ensure the latch clears any associated catch disposed on a portion of a door frame. In some embodiments, the thumb turn may be rotatable less than 90 degrees between the locking and unlocking positions.

In some embodiments, a pull handle includes a dogging fastener configured to selectively inhibit rotation of a thumb turn of the pull handle. In some embodiments, a chassis of the pull handle may include a dogging fastener receptacle. The dogging fastener may be disposed on the thumb turn and may be configured to selectively engage the dogging fastener receptacle. When the dogging fastener receptacle receives or is otherwise engaged by the dogging fastener (e.g., when the dogging fastener is in a dogging position), the dogging fastener may inhibit rotation of the thumb turn relative to the chassis. In some embodiments, the dogging fastener may be disposed at a position radially outward of an axis of rotation of the thumb turn. In some embodiments, the dogging fastener may be disposed in a dogging fastener channel of the thumb turn. For example, the dogging fastener channel may be a through hole formed in the thumb turn. The dogging fastener may be a set screw threadedly engaged with the dogging fastener channel that may be rotated to move along the dogging fastener channel. In such embodiments, when the dogging fastener is rotated, the dogging fastener may be moved to project into the dogging fastener receptacle on the chassis. In some such embodiments, a tool (e.g., a hex key) may be employed to rotate the dogging fastener. In other embodiments, the dogging fastener may be any suitable fastener that may move in any suitable direction (e.g., rotation or translation), as the present disclosure is not so limited. For example, the dogging fastener may be a pin configured to translate into engagement with the dogging fastener receptacle. According to such an example, a switch may be employed to move the dogging fastener into a dogging position.

In some embodiments, a method of operating a pull handle according to exemplary embodiments described herein includes rotating a thumb turn from a locking position to an unlocking position to move a latch from an extended position to a retracted position. The thumb turn may be coupled to the latch such that the rotation of the thumb turn is transformed into linear movement of the latch. In some embodiments, such a rotation may be against the biasing force of a biasing spring urging the latch to the extended position. The method may also include aligning a dogging fastener receptacle of a chassis with a dogging fastener channel of the thumb turn. In some embodiments, the dogging fastener receptacle and the dogging fastener channel may have a maximum transverse dimension approximately equal to one another. In some embodiments, aligning the receptacle and the channel may include aligning their respective longitudinal axes. In some embodiments, aligning the dogging fastener receptacle with the dogging fastener channel comprises aligning the thumb turn with a dogging indicator disposed on the chassis. In some embodiments, such dogging indicator may be a notch or marking formed on the chassis. The method may also include moving a dogging fastener movably disposed in the dogging fastener channel into the dogging fastener receptacle, where moving the dogging fastener into the dogging fastener receptacle inhibits rotation of the thumb turn relative to the chassis. In some embodiments, the dogging fastener may be rotated and translated into the dogging fastener receptacle. In some such embodiments, the dogging fastener may be threadedly engaged with the dogging fastener channel. In some such embodiments, the dogging fastener may threadedly engage the dogging fastener receptacle. In some embodiments a threaded dogging fastener may not threadedly engage a dogging fastener receptacle, as the present disclosure is not so limited. In some embodiments, the method may include moving a dogging fastener out of the dogging fastener receptacle and rotating a thumb turn from the unlocking position to the locking position to move the latch from the retracted position to the extended position. In some embodiments, the rotation of the thumb turn from the unlocking position to the locking position may occur automatically (e.g., under force from a biasing spring urging the latch toward the extended position).

It should be noted that while exemplary embodiments herein may be described with reference to glass doors and low-profile locking pull handles, the dogging arrangements described herein may be employed on any door or door latching device such as an exit device. Doors which may employ latching pull handles including a dogging arrangement according to exemplary embodiments herein include glass doors, metal doors, wooden doors, and composite doors. In some cases, dogging arrangements of exemplary embodiments described herein may be employed on door latching devices other than pull activated devices, such as push activated devices (e.g., exit devices), knob actuated devices, handle actuated devices, or any other suitable device having moving components where dogging is desirable.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

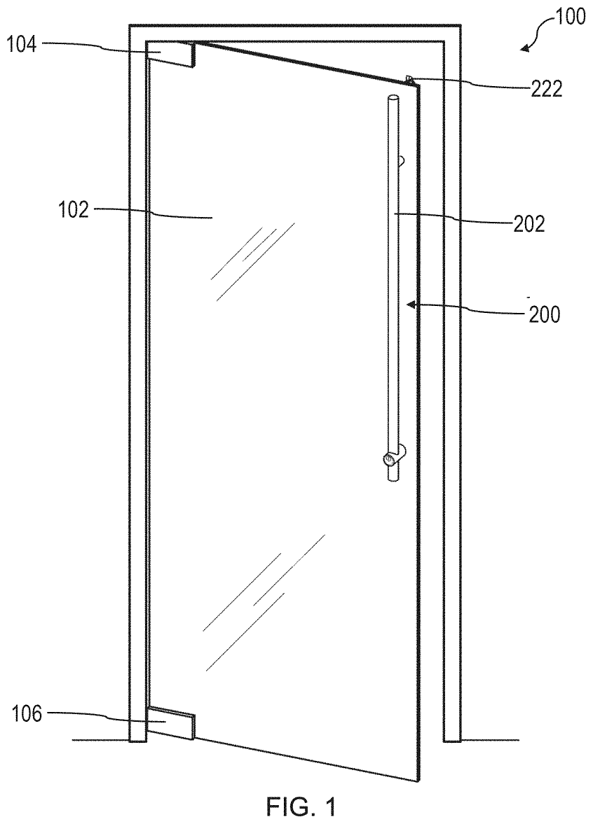

FIG. 1 is a perspective view of one embodiment of a glass door 100 including a locking pull handle 200. As shown in FIG. 1, the exit device is a low-profile pull handle which does not substantially obscure a glass panel 102 which forms the glass door. The door includes a first hinge 104, a second hinge 106 which allow the glass panel to rotate between open and closed positions. According to the embodiment of FIG. 1, the locking pull handle is rigidly attached to the glass panel 102. A chassis 202 is suspended from the glass panel and is graspable by an operator to allow an operator to operate the door. The pull handle includes a latch 222 which projects from a top of the chassis 202 and secures the door in an associated door frame transom when the latch is in the extended (e.g., engaged) position. According to the embodiment of FIG. 1 and as will be discussed further below, an actuator in the chassis is configured to move the latch to the retracted (e.g., disengaged) position to release the door when a lock cylinder or a thumb turn are rotated. Though the pull handle 200 is shown and described as being installed on a glass pane door, the present disclosure is not limited in this respect, as the pull handle may be installed on a door formed of any material or combination of materials, such as wood, metal, plastic, fiberglass and/or glass.

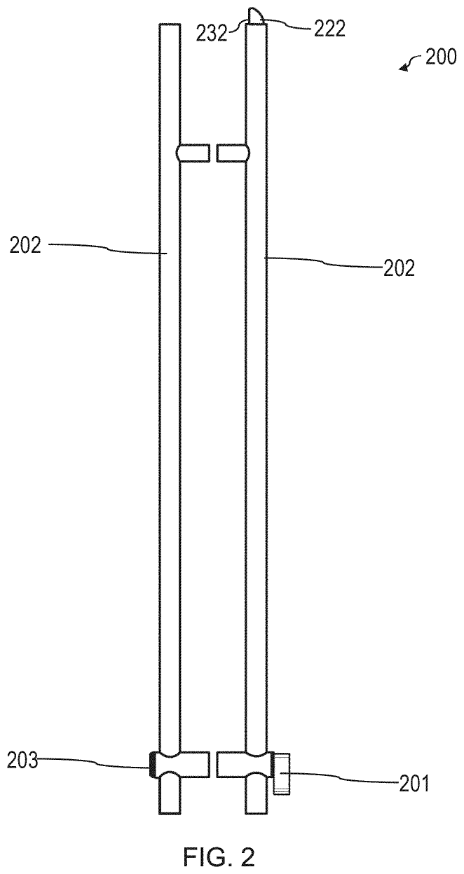

FIG. 2 is a side schematic of one embodiment of a locking pull handle 200. As shown in FIG. 2, the pull handle includes a chassis 202, which are tubular in the depicted embodiment. In particular, the chassis 202 is formed by cylindrical tubing, and form handle portion graspable by an operator. The chassis 202 is configured to be mounted to a door surface such that an operator may grasp the chassis to open the door. As shown in FIG. 2, the pull handle includes a latch 222 configured to secure the door in a closed position. The latch 22 is disposed at least partially in the chassis 202 and is configured to translate between a retracted and extended position. In the extended position shown in FIG. 2, the latch protrudes out of the chassis 202. In a retracted position, the latch may retract fully within the chassis. The chassis 202 may house a biasing spring configured to bias the latch 222 to the extended position. The pull handle also includes a thumb turn 201. The thumb turn is rotatable between a locking position and an unlocking position and is coupled to the latch 222. In the locking position the thumb turn 201 is configured to move the latch to the extended position, and in the unlocking position the thumb turn is configured to move the latch to the retracted position. The thumb turn is also coupled to a lock cylinder 203. The lock cylinder 203 is configured to receive a key to allow an operator to operate the latch similarly to the thumb turn from an exterior side of the door. The thumb turn may be disposed on an interior side of the door. In some embodiments, a key within the lock cylinder 203 may be used to rotate the thumb turn directly. The biasing spring disposed in the housing may bias the thumb turn toward the locking position.

According to the embodiment of FIG. 2, the latch 222 includes a flat locking face 232 configured to secure the door against opening. The flat locking face 232 may be oriented in a direction in which the door swings from a closed position to an open position. For example, in FIG. 2, the associated door may swing open to the left. The flat locking face of the latch may be configured to avoid generating normal forces that may urge the latch toward the retracted position. In this manner, the flat locking face improves the security of the latch compared with a curved face. The latch also includes an inclined face configured to allow the latch to automatically move from the extended position to the retracted position when the inclined face strikes a portion of a door frame. In this manner, the latch may not interfere with closure of the door.

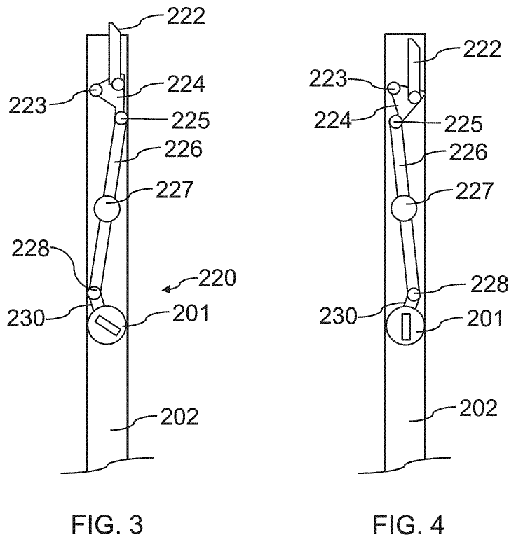

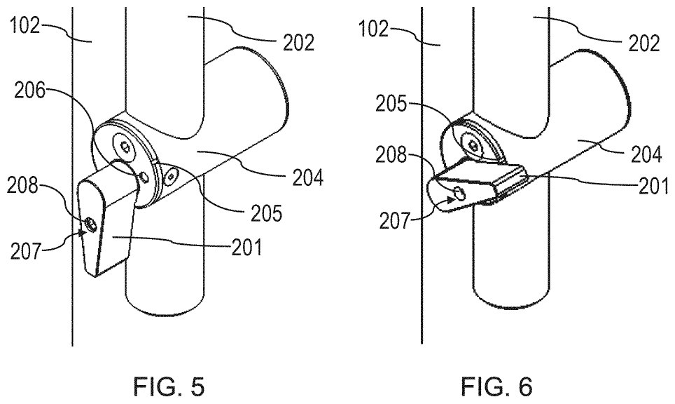

FIGS. 3-4 are schematic views of one embodiment of an actuator 220 of a pull handle in a first position and second position, respectively, showing how a thumb turn 201 may interact with components inside of a chassis 202 to operate a latch 222. It should be noted that the arrangement in FIGS. 3-4 is exemplary, and any suitable actuator or linkage between a thumb turn and a latch may be employed, as the present disclosure is not so limited. Additionally, the schematic shown in FIGS. 3-4 is dimensionally shortened and may include one or more vertical bars (not shown) configured to interconnect various components. As shown in FIGS. 3-4, the actuator includes a rotary linkage 224 which rotates about a rotary linkage pin 223, and a lever 226 which rotates about a lever pin 227. The lever is coupled to the rotary linkage at joining pin 225 so that rotation of the lever correspondingly rotates the rotary linkage to linearly move the latch 222. The lever also includes a thumb turn engagement portion 228 which is coupled with a thumb turn arm 230 fixed to an associated thumb turn 201. When the thumb turn 201 is rotated from the position shown in FIG. 3 (e.g., from a locking position toward an unlocking position), the thumb turn arm 230 engages the lever to rotate the lever in a counterclockwise position relative to the page, as shown in FIG. 4. This rotation of the lever correspondingly rotates the rotary linkage in a clockwise direction relative to the page about rotary linkage pin 223 which in turn moves the latch toward the retracted position. In some embodiments, a vertical rod, tether, or other linkage coupled to the rotary linkage may be retracted towards the actuator to correspondingly disengage the latch 222 so that the associated door may be opened. When the chassis is released from the position shown in FIG. 4, a spring or other biasing member may urge the lever, rotary linkage, and/or actuator linkage back to the position shown in FIG. 3, reversing the movement of each of the actuator coupling, lever, and rotary linkage. As will be discussed further below with reference to FIGS. 5-6, it may be desirable in some instances to maintain the actuator and latch in the state shown in FIG. 4 (e.g., with the latch in a retracted position). Accordingly, in some embodiments a pull handle may include a dogging arrangement configured to selectively secure the latch in the retracted position in a manner easy and reliable for an operator.

FIG. 5 and FIG. 6 are perspective views of one embodiment of a thumb turn 201 of a locking pull handle in a first position and second position, respectively. As shown in FIGS. 5-6, the thumb turn is rotatably mounted to a chassis 202 which in turn is mounted to a glass panel 102. In particular, the thumb turn 201 is mounted to a cylinder 204 which may house components of an actuator, in some embodiments. The thumb turn is rotatable between an unlocking position and a locking position. The locking position is shown in FIG. 5, and the unlocking position is shown in FIG. 6. According to the embodiment of FIGS. 5-6, the thumb turn may rotate less than 90 degrees between the locking and unlocking positions.

As shown in FIGS. 5-6, the chassis 202 includes a dogging fastener receptacle 206. The dogging fastener receptacle is offset from an axis of rotation of the thumb turn 201. The thumb turn 201 includes a dogging fastener channel 207 which houses a dogging fastener. In some embodiments as shown in FIG. 5, the dogging fastener channel is a through hole formed in the thumb turn. The dogging fastener is movable disposed in the dogging fastener channel. In the embodiment of FIGS. 5-6, the dogging fastener is configured as a set screw that is threadedly engaged with the dogging fastener channel. The dogging fastener may be configured to receive a tool (e.g., a hex key, screwdriver, etc.) to assist in rotating the dogging fastener. When the dogging fastener is rotated, the dogging fastener may protrude out of the thumb turn toward the chassis 202. Accordingly, when the dogging fastener receptacle 206 and the dogging fastener channel 207 are aligned (e.g., their longitudinal axes are coincident) the dogging fastener may be able to engage the dogging receptacle. In some embodiments, the dogging fastener receptacle may also be threaded and may accordingly threadedly engage the dogging fastener. The dogging fastener may be configured to move between a dogging position, where the dogging fastener is engaged with the dogging fastener receptacle, and an undogging position, where the dogging fastener is disengaged and clears the dogging fastener receptacle. With the dogging fastener engaged with the dogging fastener receptacle, the thumb turn may be unable to rotate relative to the chassis. Accordingly, the dogging fastener may hold the thumb turn in the unlocking position as shown in FIG. 6. As shown in FIGS. 5-6, the chassis 202 may include a dogging indicator 205 formed on the chassis that is configured to assist an operator in aligning the dogging fastener receptacle and the dogging fastener channel. In the depicted embodiment, alignment of the thumb turn itself with the dogging indicator 205 may indicate alignment of the dogging fastener receptacle and the dogging fastener channel.

The process of using the dogging fastener 208 begins in FIG. 5. With the dogging fastener in an undogging position and the thumb turn 201 in a locking position, the thumb turn may be rotated to an unlocking position as shown in FIG. 6. In some embodiments, the unlocking position may be indicated by the dogging indicator 205. In the unlocking position, the dogging fastener receptacle 206 may be aligned with the dogging fastener 208 disposed in the dogging fastener channel 207. While aligned, the dogging faster may be moved (e.g., translated and/or rotated) to the dogging position where the dogging fastener engages the dogging receptacle. Once the dogging fastener is received in the dogging receptacle, the thumb turn 201 may be unable to rotate toward the locking position. Accordingly, the dogging fastener may hold an associated latch in a retracted position against any biasing force via the thumb turn 201. To release the thumb turn 201, the dogging fastener may be moved to the undogging position (e.g., by translating and/or rotating the dogging fastener in a reverse direction).

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A pull handle comprising:
a chassis including a handle portion configured to be grasped by an operator;
a latch disposed at least partially in the chassis and configured to move between an extended position and a retracted position, wherein in the extended position the latch is configured to protrude out of the chassis;
a thumb turn rotatable between a locking position and an unlocking position, wherein the thumb turn is coupled to the latch such that when the thumb turn is in the locking position the latch is in the extended position and when the thumb turn is in the unlocking position the latch is in the retracted position; and
a dogging fastener disposed on the thumb turn and configured to move between a dogging position and an undogging position, wherein in the dogging position the dogging fastener engages the chassis to inhibit rotation of the thumb turn relative to the chassis.

2. The pull handle of claim 1, wherein the chassis includes a dogging fastener receptacle, wherein the dogging fastener is configured to engage the dogging fastener receptacle in the dogging position.

3. The pull handle of claim 2, wherein the dogging fastener is configured to threadedly engage the dogging fastener receptacle.

4. The pull handle of claim 2, wherein the thumb turn includes a dogging fastener channel configured to align with the dogging fastener receptacle when the thumb turn is in the unlocking position, wherein the dogging fastener is movable disposed in the dogging fastener channel.

5. The pull handle of claim 4, wherein the dogging fastener is threadedly engaged with the dogging fastener channel such that rotation of the dogging fastener translates the dogging fastener in the dogging fastener channel.

6. The pull handle of claim 4, wherein the dogging fastener channel is a through hole.

7. The pull handle of claim 6, wherein the dogging fastener is configured to receive a tool external to the thumb turn.

8. The pull handle of claim 4, wherein the chassis further comprising a dogging indicator, wherein aligning the thumb turn with the dogging indicator aligns the dogging fastener receptacle with the dogging fastener channel.

9. The pull handle of claim 1, wherein the dogging fastener is a set screw.

10. A method of operating a pull handle, the method comprising:
rotating a thumb turn of the pull handle from a locking position to an unlocking position to move a latch of the pull handle from an extended position to a retracted position; and
moving a dogging fastener from an undogging position to a dogging position to engage a chassis of the pull handle, wherein engaging the chassis with the dogging fastener inhibits rotation of the thumb turn relative to the chassis.

11. The method of claim 10, further comprising aligning a dogging fastener receptacle of the chassis with a dogging fastener channel of the thumb turn prior to moving the dogging fastener to the dogging position, wherein the dogging fastener is movably disposed in the dogging fastener channel, and wherein engaging the chassis with the dogging fastener comprises engaging the dogging fastener receptacle with the dogging fastener.

12. The method of claim 11, wherein aligning the dogging fastener receptacle with the dogging fastener channel comprises aligning the thumb turn with a dogging indicator disposed on the chassis.

13. The method of claim 11, wherein moving the dogging fastener comprises rotating the dogging fastener within the dogging fastener receptacle.

14. The method of claim 12, wherein the dogging fastener is threadedly engaged with the dogging fastener receptacle.

15. The method of claim 11, wherein engaging the dogging fastener receptacle with the dogging fastener comprises threadedly engaging the dogging fastener receptacle with the dogging fastener.

16. The method of claim 11, further comprising:
moving the dogging fastener out engagement with the dogging fastener receptacle; and
rotating the thumb turn from the unlocking position to the locking position to move the latch from the retracted position to the extended position.
